(19) United States
(12) Patent Application Publication
(10) Pub. No.: US 2002/0128815 A1
(43) Pub. Date: Sep. 12, 2002

(54) Automatic configuration of a data storage system

(76) Inventors: Arif A. Merchant, Los Altos, CA (US); John Wilkes, Palo Alto, CA (US); Mirjana Spasojevic, Palo Alto, CA (US); Ying Chen, San Jose, CA (US); Eric Anderson, Berkeley, CA (US); Alistair Craig Veitch, Mountain View, CA (US)

Correspondence Address: HEWLETT-PACKARD COMPANY, Intellectual Property Administration, P. O. Box 272400, Fort Collins, CO, 80527-2400, US

(21) Appl. No.: 09/755,891

(22) Filed: Jan. 6, 2001

(51) Int. Cl. G06F 17/28

(52) U.S. Cl. 704/2

(57) ABSTRACT

A high-level language description of a data storage system is generated and translated, directly or indirectly, into specific configuration commands.

### BACKGROUND

The present invention relates to data storage systems. More specifically, the present invention relates to configuring data storage systems.

Consider the following example of configuring a data storage system. A description of a target storage system is generated; certain devices are queried to determine their initial configuration; a series of device/host-specific commands are generated (that is, specific to the hosts and devices being configured); and the commands are sent to the devices. The device/host commands specify how the storage devices and the hosts' access to them should be configured.

Configuring a data storage system involves a great deal of manual labor. For instance, a human operator generates many pages of device/host-specific commands. Each command is typed into a computer and sent to either a host or a device. Manual labor can make it very slow and error prone to configure the data storage system.

Configuring the data storage system also requires a detailed understanding of the specific commands for each data storage device and each host in the system. For example, different disk arrays might be configured by different commands to set configuration parameters including, but not limited to, data-layout choice, parity-layout choice, disks used, stripe width, cache size, and write-back policies. Setting these parameters requires detailed knowledge of each disk array.

This problem is compounded if the data storage system includes devices made by different manufacturers. Data storage devices made by different manufacturers are usually configured by different device-specific commands. This problem is further compounded if the data storage system includes hosts having different operating systems. Hosts having different operating systems, OS versions, or logical volume managers are usually configured by different host-specific commands.

Typing in the commands is prone to human error. It is not unusual for an operator to type pages of commands. Yet typing in one wrong command can result in misconfiguration, loss of data, poor performance and other problems with the data storage system. The chance of error is even greater when the commands are entered interactively.

A large enterprise system typically deals with many terabytes of data spread over a range of physical devices. The difficulties inherent in configuration are compounded by the scale of such a system.

### SUMMARY

According to one aspect of the present invention, a data storage system is configured by using a high-level description (e.g., a description specifying configuration goals or a description specifying device/host-independent commands) of the data storage system. Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of an enterprise system including a data storage system;

FIG. 2 is an illustration of a method for configuring the data storage system;

FIG. 3 is an illustration of a disk array;

FIG. 4 is an illustration of a hardware implementation of the method shown in FIG. 2; and

FIG. 5 is an illustration of an alternative method for configuring the data storage system.

### DETAILED DESCRIPTION

As shown in the drawings for purposes of illustration, the present invention is embodied in a method and apparatus for configuring a data storage system. The data storage system is configured by generating a high-level language description (e.g., a description specifying configuration goals or a description specifying device/host-independent commands) of the data storage system and then translating the description into device/host-specific commands. The high-level language description is more intuitive than device/host-specific commands and, therefore, easier for people to learn and use. The high-level language description can be generated without the need for a detailed understanding of the devices and hosts.

The high-level language description is applicable to a greater number of circumstances than device/host-specific commands. For example, specific commands might fail if they do not take the correct starting states into account. Applicability to a greater number of circumstances reduces the chance of errors.

A description containing high-level language is typically shorter than a script containing corresponding device/host-specific commands. Thus, the chance of typing in a wrong command is reduced. Error checking can be performed during translation, which further reduces the chance of error.

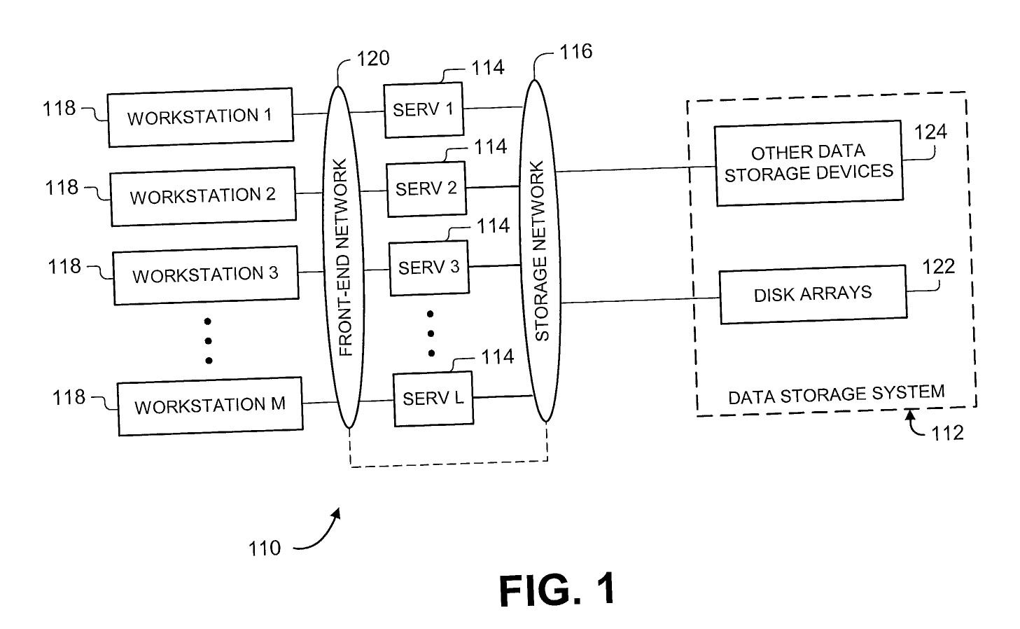

Reference is now made to FIG. 1, which shows an example of an enterprise system 110 including a data storage system 112 and a plurality of servers 114 that communicate with the data storage system 112 via a network 116 (e.g., a fiber-channel network). The servers 114 communicate with a plurality of workstations 118 via a front-end network 120. Alternatively, the workstations 118 may bypass the servers 114 and communicate directly with the network 116 (as shown by the dashed line). Throughout this application, the servers 114 and workstations 118 will be referred to collectively as “hosts” 114, 118.

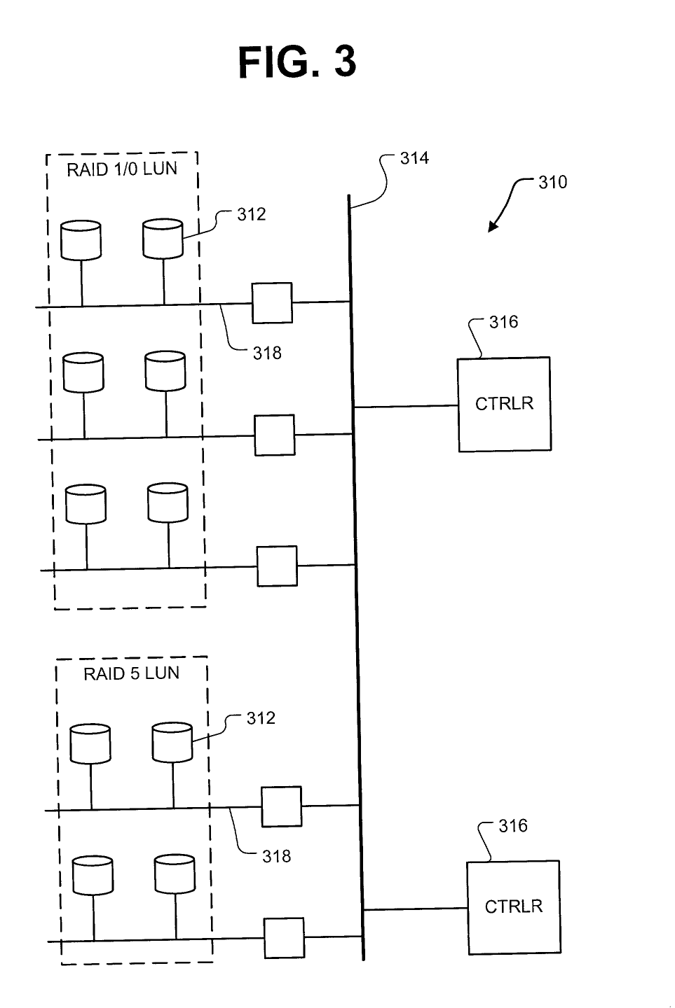

The data storage system 112 includes a plurality of disk arrays 122 connected to the network 116. An exemplary disk array is described below in connection with FIG. 3.

The data storage system 112 may also include other types of data storage devices 124. The other types of data storage devices 124 may include, without limitation, network-attached storage devices (NASD), and standalone disks and RAID cards of computers. The NASD might include any number and types of drives, such as hard drives, optical drives, and tape drives.

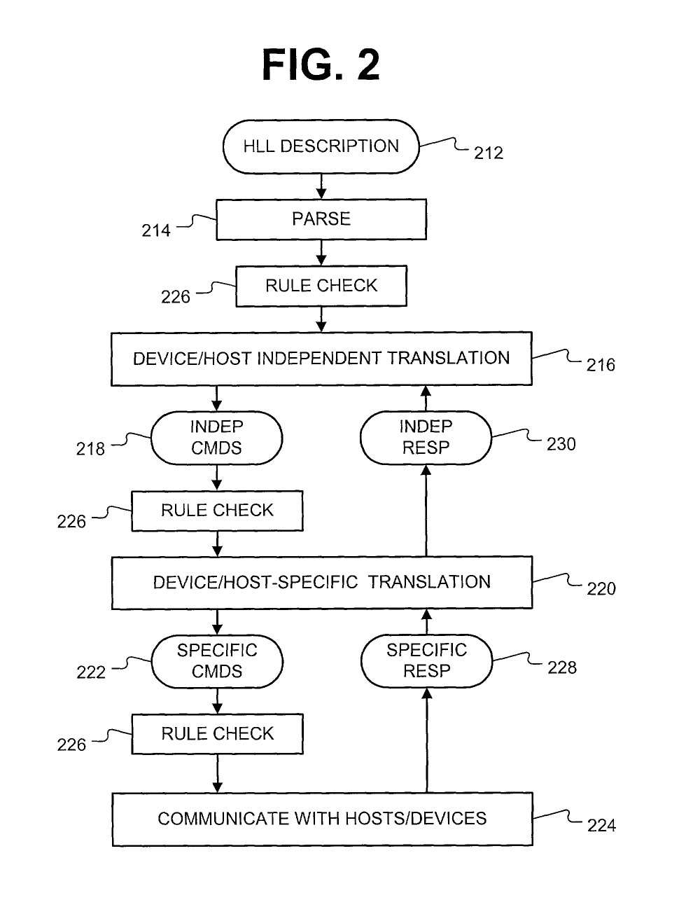

The data storage devices 122, 124 of the data storage systems 112 may be configured by one or more of the hosts 114, 118. The hosts 114, 118 may configure the data storage devices 122, 124 by following the exemplary method of FIG. 2.

Reference is now made to FIG. 2, which shows the exemplary method. First, a high-level language description 212 is generated. The description 212 does not contain device/host-specific commands for configuring the devices 122, 124 in the data storage system 112. Instead the description 212 identifies what needs to be done to configure the data storage system 112. The description 212 may specify goals for configuring the data storage devices 122, 124 (rather than steps for indicating how to configure the system 112). For example, the description 212 might describe logical units (LUNs), redundancy levels for disk arrays, network connections and topologies, description of logical units to controllers, and so on.

The description 212 might also describe the allocation of data across the data storage system 112. For example, files with high I/O activity may be placed on the same drive as files with low I/O activity. Data might be striped across multiple physical drives by spreading a LUN across multiple physical drives or by spreading a logical volume across multiple LUNs.

Thus the high-level language description 212 is written in a “declarative” language that specifies a desired configuration for the data storage system 112. Examples of the goal-based high-level language are provided below in Table I.

The same goal-based high-level language description may be used to configure different disk arrays, even if those disk arrays are configured by different sets of device-specific commands. Similarly, the same goal-based high-level language description may be used for mapping data space for different hosts, even if those hosts are configured by different sets of host-specific commands.

The high-level language may be extensible. Two sets of commands may be provided: a set of “standard” commands and a set of device extensions. Extensibility allows the addition of more standard commands and the system to take advantage of a device-specific or host-specific functionality. For example, the same high-level language may have support for remote mirroring, a device-specific functionality that applies only to certain arrays but is invalid for others. Similarly, new RAID levels may be added and supported. New host policies (e.g., caching, write-back) may be embedded without invalidating pre-existing instances of the high-level language.

The goal-based high-level language is more intuitive than commands, which specify how to configure the devices 122, 124. Therefore, the goal-based language is easier for people to learn and use.

After the description 212 is generated, it may be displayed (e.g., printed). The displayed description 212 may be manually proof read and corrected. Since the description 212 is written in a high-level language, it is usually shorter and easier to read than a script containing corresponding device/host-specific commands. It is also easier to generate, with less chance of error.

The description 212 may be parsed into device-related high-level language and host-related high-level language (block 214). The high-level language is then translated (block 216) into device/host-independent commands 218. The device/host-independent commands 218 specify general steps (as opposed to goals) that should be performed to attain the desired configuration of the data storage system 112. They are “generic” commands and are not specific to any particular host or device. Examples of the device/host-independent commands 218 are provided below in Table II.

The device/host-independent commands 218 are translated into device/host-specific commands 222 (block 220). The hosts 114, 118 execute the specific commands to send signals to the devices 122, 124 (block 224). The devices respond to these configuration signals by, for example, setting parameters specified by the signals. Examples of device/host-specific commands 222 are provided in Table III.

Rule checking may be performed (block 226) at various stages to determine whether a goal or command violates a rule. If a rule is violated, the invalid goal OR command can be displayed and subsequently corrected. For example, specifying RAID 1 for an odd number of disks would violate a rule. Specifying remote mirroring between invalid combinations of devices would violate a rule.

Some devices might require interaction (that is, bi-directional communication) during configuration. It might be necessary to query certain devices for their current configuration before issuing the device-specific commands. Examples of interactive commands are provided in Table IV.

Device/host-specific commands 222 can be generated (block 220) to query such devices. The data storage devices 122, 124 respond by issuing device/host-specific responses 228. The device/host-specific responses 228 are translated (block 220) into device/host-independent responses 230, and the device/host-independent commands 218 are generated (block 216) from the device/host-independent responses 230.

After the data storage devices 122, 124 are configured, a host configuration such as a Logical Volume configuration is performed: the hosts 114, 118 are queried to determine their initial configuration; and a series of host-specific commands are generated and sent to the hosts. The host-specific commands specify how user data space should be mapped on the data storage devices 122, 124. After the host configuration has been performed, the data may be written to the storage devices.

If the desired configuration or properties of the data storage system 112 changes, a new high-level language description could be generated and translated, directly or indirectly, into the device/host-specific commands.

Because querying allows the initial configuration of a data storage device to be determined, the device/host-independent commands may be generated only for those parameters that need to be changed. For example, a LUN state of a disk array may be queried, and only those LUNs that have changed would be rebound.

Reference is now made to FIG. 3, which shows an example of a disk array 310. This example is provided to support the exemplary language provided below in Tables I, II, III and IV. The disk array 310 includes a set of disks 312, a bus interconnect 314 and controllers 316. Each controller 316 may include a processor, RAM, control logic, parity logic and cache for staging data, and speed-matching buffers. Back-end buses 318 provide connections between the disks 312 and the bus interconnect 314. The disk array 310 typically offers a great number of configuration parameters including, but not limited to, data-layout choice, parity-layout choice, stripe depth, stripe width, cache size, and write-back policies.

A front-end bus or point-to-point connection (not shown) provides connections between the controllers 316 and hosts. The controllers 316 receive signals from the hosts and set the characteristics of the disk array 310 according to those signals.

Table I provides an example of high-level language for creating two different LUNs: a six-disk RAID 1/0 LUN that is accessed through a first controller 312, and a four-disk RAID 5 LUN that is accessed through a second controller 312. The LUNS have different stripe sizes, and the two controllers 312 have different cache page sizes.

Table II provides examples of device/host-independent commands, and Table III provides examples of device/host-specific commands. The remaining commands provided in Table IV are generated interactively.

TABLE I
## Examples of high-level language description

device gershwin {

{ controller ctl_A {

{ cachepageSize 4096 }

}}

{ controller ctl_B {

{ cachepageSize 16384 }

}}
{ instanceOf HpSureStore_FC60 }
{ lun 0 {

{ controller A }
{ layout ( raid 1 } }
{ stripeUnitSize 65536 }
{ targets {..A.0.0 ..B.0.0 ..C.0.0 ..D.0.0 ..E.0.0 ..F.0.0 } }

}}
{ lun 1 {

{ controller A }
{ layout ( raid 5 } }
{ stripeUnitSize 16384 }
{ targets { ..A.1.1 ..B.1.1 ..C.1.1 ..D.1.1 } }

}}

}
store data_week_1 {

{ capacity 500MB } # How big is this logical volume
{ boundTo ( gershwin_0.0 gershwin_0.1 ) } # Which logical

#volume does this store go on?

{ lvStripeSize 256k }

}
store index_week_1 {

{ capacity 100MB }
{ boundTo gershwin_0.0 }

}

TABLE II
##Examples of device/host-independent commands

(arrays...) = findArrays()
array->createLUN(number, type, layout, layout-options, targets,

options)

array->destroyLUN (number)
array->configureController(controller, options)
(volumes...) = findVolumes()
volume = createVolumeGroup(name)
volume->addPhysicalDevice(device-name)
volume -> createLogicalVolume(name, size, options)
volume- >removeLogicalVolume(name)

TABLE III

## Examples of device/host-specific commands
mkdir/dev/vgexample
mknod/dev/vgexample/group c 64 0 × 030000
pvcreate/dev/rdsk/c23t0d4
vgcreate −e 256 −s 64 /dev/vgexample/dev/dsk/c2t0d4
vgextend /dev/vgexample/dev/dsk/c23t0d5
amcfg −R 0 −d 1:8, 2:8, 3:8, 4:8, 5:8, 6:8 −r 1 −s 64 gershwin
amcfg −L 1 −d 1:3, 2:3, 3:3, 4:3 −r 5 −s 16 gershwin
amcfg −D 2 gershwin
ammgr −p 16384 gershwin

TABLE IV

## Examples of interactive commands
select device 8/12.8.0.255.1.3
xt
bindlun
. . . sundry configuration dependent responses . . .
exit
select device 8/12.8.0.255.1.3
xt
bindlun
. . . more configuration dependent responses . . .
exit
exit

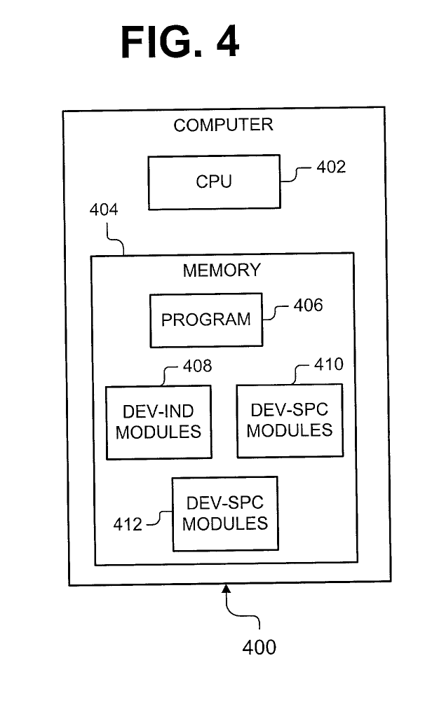

Reference is now made to FIG. 4. The method above may be executed by a computer 400 including one or more central processing units 402 and persistent memory 404 (e.g., one or more hard drives). In the alternative, the central processing unit(s) 402 and the persistent memory 404 may be in separate boxes. The persistent memory 404 stores a program 406 (including executable instructions and data) for instructing the central processing unit(s) 402 to translate the high-level language description 212 into the device/host-specific commands 222. The program 406 may instruct the central processing unit(s) 402 to accept the high-level language description 212 as an electronic file.

The memory 404 also stores different modules 408, 410 and 412. Device-independent modules 408 provide information that allows the device-related high-level language to be translated to device/host-independent commands. Device-specific modules provide information that allows the device-independent commands to be translated to device-specific commands. Each device-specific module 410 corresponds to a device class and may relate the device-specific commands to the device-independent commands. The device-specific modules 410 may be provided by device manufacturers.

Host-specific modules 412 provide information that allows the host-independent commands to be translated to device-specific commands. Each host-specific module 412 corresponds to a host class (i.e., a class of hosts having similar hardware, operating systems, software configurations, etc.). Host-specific modules 412 may be provided by host manufacturers.

If a new type of data storage device is added to the data storage system 112, the device/host-independent commands should still be usable for the new device; therefore, only a device-specific module 410 need be loaded into the computer 400. If a new host class is added to the enterprise system 110, the device/host-independent commands should still be usable for the new host; therefore, only a host-specific module 412 need be loaded into the computer 400. Thus the data storage system configuration according to the present invention is easy to extend to new devices.

Computers other than the hosts 114, 118 can generate the independent and specific commands. For example, a migration tool (e.g., running in a standalone computer) could generate certain commands and send these commands to one or more hosts 114, 118. The migration tool could generate the device/host-specific commands and send the specific commands to the hosts 114, 118. In the alternative, the migration tool could generate the device/host-independent commands only and send the device/host-independent commands to the hosts (which would include the modules 410, 412 for performing the translation to specific commands).

The invention is not limited to translating a goal-based high-level language to independent commands and then performing the additional translation to specific commands. The high-level language of the description 212 may instead be translated from a goal-based high-level language description directly into device-specific commands. However, by using the independent commands, the configuration method is easier to extend. If independent commands describing new functionality are added, the new functionality is available to all devices.

Although the high-level language description has been described above as a language that specifies system configuration goals, it is not so limited. The high-level language may instead specify device/host-independent commands.

The description may be extended by adding device/host specific language to the goal-based or independent command-based language.

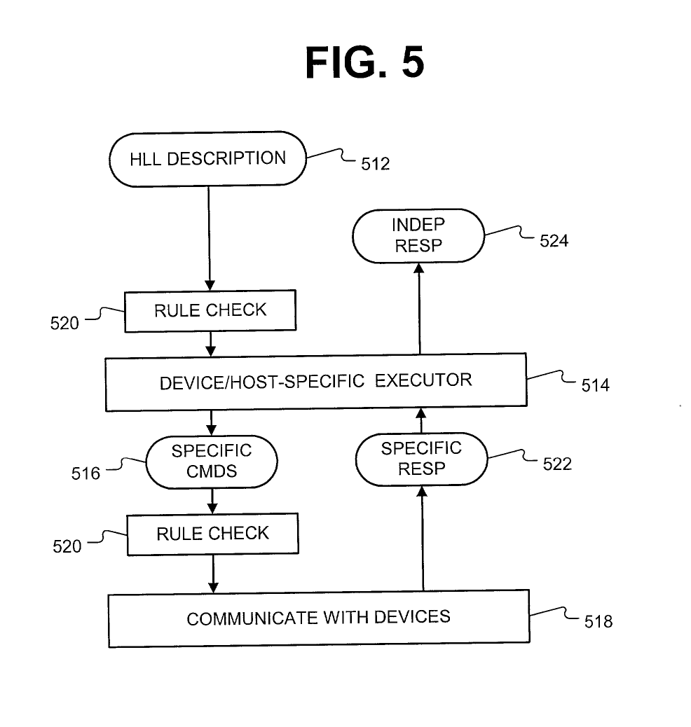

Referring to FIG. 5, such a high-level language 512 is rule-checked (520) and translated directly into device/host-specific commands (blocks 514 and 516). Specific commands may also be generated interactively.

The invention is not limited to high-level language and specific commands that configure devices. For example, a high-level language could describe configuration goals for a file system, and the description could be translated into specific commands that create the file system.

The invention is not limited to the specific embodiments described and illustrated above. Instead, the invention is construed according to the claims that follow.

What is claimed is:

1. A method of configuring a data storage system, the method comprising using a high-level language description to configure the data storage system.

2. The method of claim 1, wherein the high-level language specifies configuration goals.

3. The method of claim 1, wherein the high-level language description includes a declarative language.

4. The method of claim 1, wherein the high-level language includes generic configuration commands.

5. The method of claim 1, wherein the high-level language description includes device/host-independent commands.

6. The method of claim 1, further comprising the step of translating the high-level language description into device/host-specific commands.

7. The method of claim 6, wherein the high-level language description is translated directly into the device/host-specific commands.

8. The method of claim 6, wherein the high-level language description is translated into device/host-independent commands and the device/host-independent commands are translated into device/host-specific commands.

9. The method of claim 8, wherein first software modules are accessed to translate the high-level language description into the independent commands; and wherein second software modules are accessed to translate the independent commands into the specific commands.

10. The method of claim 6, further comprising performing rule checking on the high-level language description and the commands.

11. The method of claim 6, wherein specific commands are generated only for device/host parameters that should be changed.

12. The method of claim 6, further comprising translating the high-level description into device-specific queries, and generating commands from responses to the queries.

13. A method for configuring a data storage device, the method comprising:
generating a high-level language description that specifies configuration goals for the data storage device; and
translating the high-level language description into device/host-independent commands.

14. The method of claim 13, further comprising sending the device/host-independent commands to a host that can communicate with the data storage device.

15. The method of claim 13, further comprising translating the device/host-independent commands into device/host-specific commands.

16. The method of claim 15 further comprising executing the device/host-specific commands to configure the data storage device.

17. The method of claim 15, wherein commands are generated only for those device/host parameters that will be changed.

18. The method of claim 13, further comprising performing rule checking on the high-level language description and the commands.

19. The method of claim 13, wherein the data storage device is a disk array.

20. Apparatus for configuring a data storage system, the apparatus comprising a processor for processing a high-level language description of the data storage system into configuration commands.

21. The apparatus of claim 20, wherein the processor also translates the high-level language description into commands

22. The apparatus of claim 21, wherein the processor translates the high-level language description directly into device/host-specific commands

23. The apparatus of claim 21, further comprising memory for storing first and second modules, each first module translating high-level language into independent commands, each second module translating independent commands into specific commands.

24. The apparatus of claim 21, wherein the processor also performs rule checking on the high-level language description and the commands.

25. The apparatus of claim 21, wherein the processor generates commands are generated only for device/host parameters that should be changed.

26. The apparatus of claim 21 wherein the processor also queries devices of the data storage system, and generates commands from responses to the queries.

27. An article for instructing a processor to configure a data storage system, the article comprising:
computer memory; and
data encoded in the computer memory, the data instructing the processor to process a high-level language description of the data storage system; and translate the high-level description into specific commands.
